(19) United States
(12) Patent Application Publication
(10) Pub. No.: US 2006/0081673 A1
(43) Pub. Date: Apr. 20, 2006

(54) Device and method for breaking glass panes

(75) Inventors: Mark Schenk, Taichung (TW); Bernhard Manz, Herzogenbuchsee (CH)

Correspondence Address: FOLEY AND LARDNER LLP;SUITE 500, 3000 K STREET NW, WASHINGTON, DC, 20007, US

(73) Assignee: Bystronic Maschinen AG

(21) Appl. No.: 11/249,450

(22) Filed: Oct. 14, 2005

(30) Foreign Application Priority Data
Oct. 15, 2004 (EP) 04405645.5

(51) Int. Cl. B26F 3/00

(52) U.S. Cl. 225/1

(57) ABSTRACT

The device for breaking a glass pane (90) comprises at least one first breaking body (71) that is displaceable along the front side (90a) of the glass pane, at least one second breaking body (72) that is displaceable along the back side (90b) of the glass pane, and a flexible support (49) that serves for supporting the glass pane and that is arranged between the two breaking bodies. According to the method for breaking a glass pane the two breaking bodies are displaced synchronously. The device and the method simplify the production of glass panes of any desired shape, particularly since a template corresponding to the shape is no longer required.

### FIELD OF THE INVENTION

The invention refers to a device and a method for breaking glass panes.

### Background of the Invention

For producing glass panes having a determined shape such as they are e.g. used for rear windows or windshields in automobiles, the raw glass panes are first scribed and then broken. In a manner known in the art, a template corresponding to the desired shape of the pane is used for breaking the pane. To this end, the scribed glass pane is laid on top of the template and then the projecting edge of the glass pane is broken off by means of a breaking wheel or a breaking ball (see e.g. the patent specification EP-A2-1 367 027 to the applicant of the present invention). The disadvantage of this procedure is that a separate template must be manufactured and stored for each desired pane shape, thereby making the production of glass panes having predetermined user-defined contours laborious and expensive.

### SUMMARY OF THE INVENTION

Based on this prior art, the object of the present invention is to provide a device and a method allowing a simplified production of glass panes having predetermined user-defined contours.

According to a first aspect of the invention this object is accomplished by a device comprising at least one first breaking body that is displaceable along the front side of the glass pane, at least one second breaking body that is displaceable along the back side of the glass pane, and a flexible support that serves for supporting the glass pane and that is arranged between the two breaking bodies.

According to a second aspect of the invention there is provided a method comprising displacing a first breaking body along the front side of the glass pane and a second breaking body along the back side of the glass pane, the breaking bodies being displaced synchronously.

The device and the method of the invention offer the advantage, amongst others, that templates are no longer required for breaking a glass pane and therefore the production of glass panes having user-defined contours is more economical and simpler.

### BRIEF DESCRIPTION OF THE DRAWINGS

The invention will be explained hereinafter by means of an exemplary embodiment and with reference to figures, where:

FIG. 1 shows a perspective view of an installation including a device for breaking a glass pane according to the invention;

FIG. 2 shows a partially sectioned partial side view of the device according to FIG. 1;

FIG. 3 shows the side view of FIG. 2 during the breaking procedure; and

FIG. 4 shows an example of a scribed glass pane in a top view.

### DETAILED DESCRIPTION OF THE PREFERRED EMBODIMENTS

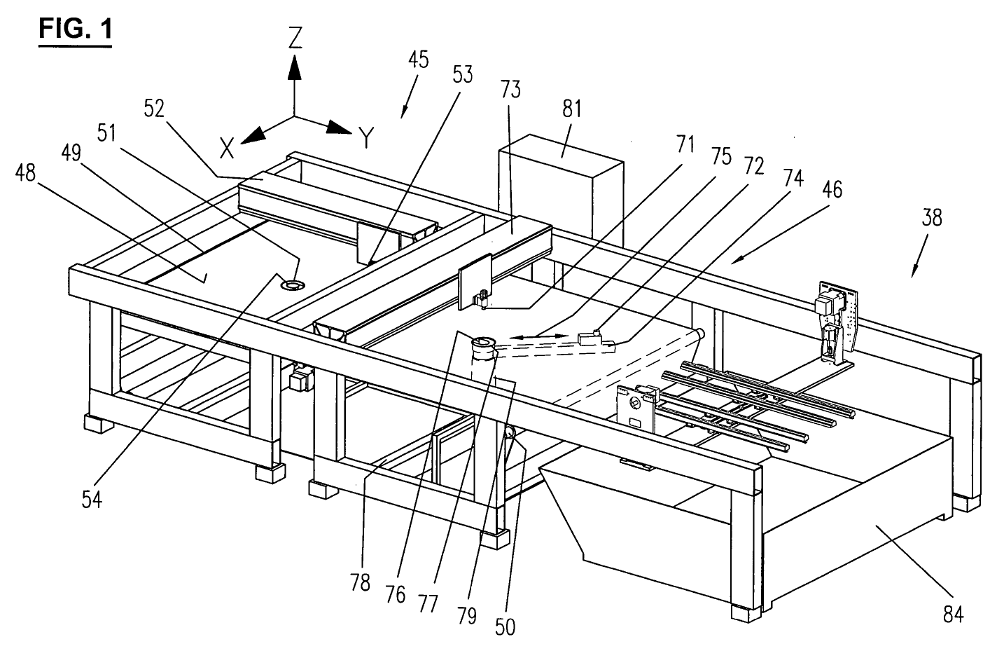

The installation illustrated in FIG. 1 comprises a cutting station 45, a breaking station 46, and an endless conveyor belt 49 running on deflecting pulleys 50. At least one of the deflecting pulleys 50 can be driven. On one hand, conveyor belt 49 serves as a supporting surface 48 for the glass pane that is to be processed. On the other hand, the upper side of conveyor belt 49 is movable in the y direction for transporting the glass pane from cutting station 45 to breaking station 46 and eventually the broken off glass pieces from breaking station 46 to a following collecting container 84.

Cutting station 45 comprises a cutting bridge 52 that is arranged above conveyor belt 49. Cutting bridge 52 is displaceable in the x direction and provided with a cutting head 53 that is displaceable in the y direction as well as in the vertical z direction and that is rotatable. Cutting bridge 52 and cutting head 53 are moved by a control system 81 that allows a precise displacement of cutting head 53 in space as well as a precise rotation about the vertical axis in order to provide a glass pane with scribing lines of any desired shape. Cutting station 45 further comprises a suction device 54 that can be put through an opening 51 of conveyor belt 49 and affixed to the underside of the glass pane.

Breaking station 46 comprises a breaking device including a first breaking body 71 displaceable along the front side of the glass pane and a second breaking body 72 displaceable along the back side of the glass pane. First breaking body 71 is mounted displaceably in the x direction and in the vertical z direction on a bridge 73 that is displaceable in the y direction. A cross beam 78 having a vertical column 79 with an arm 74 fastened thereto is located between the upper part of conveyor belt 49 moving in the positive y direction and its lower part moving in the negative y direction. Arm 74 is rotatable about column 79, and second breaking body 72 is arranged displaceably along arm 74, as indicated by double arrow 75 in FIG. 1. Second breaking body 72 is thus displaceable in the xy plane by moving it along arm 74 and/or by rotating arm 74.

Synchronizing means that are e.g. integrated in control system 81 are operatively connected to the breaking device in order to displace breaking bodies 71 and 72 in a mutually synchronized manner. A CNC control is for instance suitable as a control system 81 for the controlled displacement of breaking bodies 71 and 72. Alternatively, it would be conceivable, though a little more complicated, to synchronize the movements of the two breaking bodies 71 and 72 by mechanical synchronizing means such as gearwheels and/or rod systems.

The breaking station further comprises holding means 77 for holding the glass pane during the breaking process. In the embodiment shown in FIG. 1, holding means 77 are in the form of a suction device integrated in column 79. Suction device 77 can be put through an opening 76 in conveyor belt 49 and affixed to the underside of the glass pane. Opening 76 may also be omitted since conveyor belt 79 can be displaced so that opening 51 is positioned above suction device 77.

Furthermore, holding means 77 may comprise several suction devices that are adapted to be fixed on the glass pane, and/or a punched design of conveyor belt 79 so as to attach the glass pane firmly to conveyor belt 79 by creating a vacuum.

At the end of breaking station 46, a transfer device 38 is provided which is displaceable in the y direction for taking over and removing the glass pane after the breaking process. The latter is e.g. forwarded to a following processing station for further processing steps such as grinding and/or drilling procedures or to a suitable storage facility for temporary storage.

Breaking station 46 with breaking device 71, 72 need not be arranged next to cutting station 45 but may be free-standing or connected to other stations for further processing of the glass pane, depending on the intended purpose.

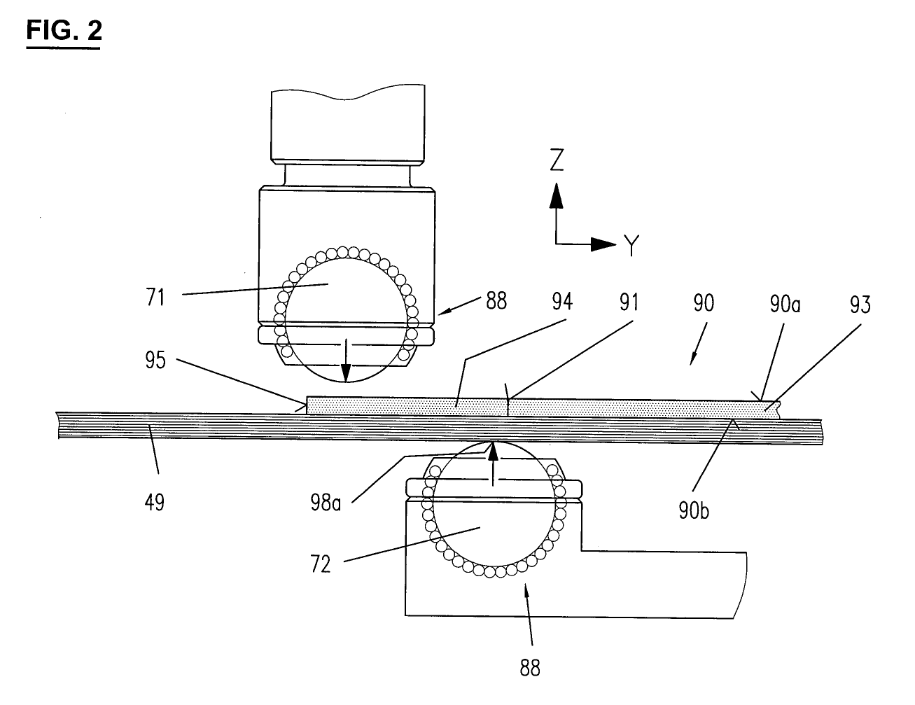

FIG. 2 shows a detail view of the breaking device. The two breaking bodies 71 and 72 have a spherical configuration and are each supported freely rotatably in all directions by means of suitable bearings 88, e.g. ball bearings. Instead of balls, first breaking body 71 and/or second breaking body 72 may also be designed as rollers. In this case, an additional driving system is required for rotating the roller about the vertical z axis in order to align it to the moving direction as it is rolling along the glass surface.

The conveyor belt 49 extends between the two breaking bodies 71 and 72 and forms a support 49 for glass pane 90. Support 49 consists of a flexible material that is chosen such as to be capable of carrying the weight of glass pane 90 without major sagging, on one hand, and of giving way when a pressure is exerted on the surface of the glass pane, on the other hand (cf. the following explanation with reference to FIGS. 2-4). Suitable materials for support 49 are e.g. plastic materials having a selected elasticity or a fabric belt, more particularly a fabric belt composed of plastic fibers.

For producing glass panes having desired predetermined contours, the following procedure is applied:

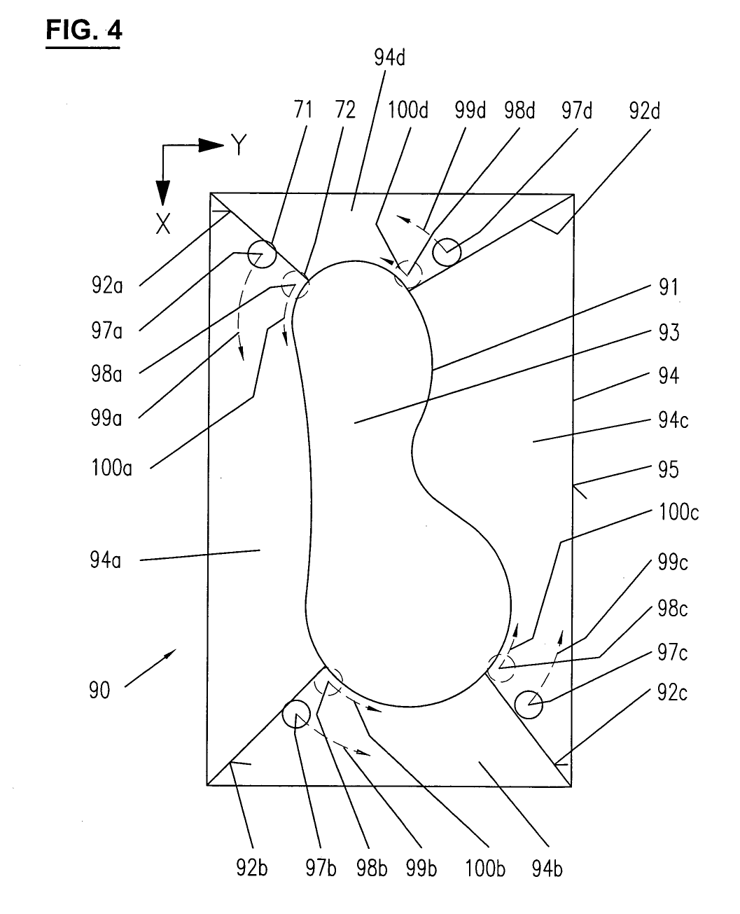

The raw glass pane is laid on conveyor belt 49 and held in place by means of suction device 54. The glass pane is scribed according to the predetermined pattern by controlled displacement of cutting head 53. FIG. 4 shows an example of a glass pane 90 provided with scribing lines 91 and 92a-92d. Scribing line 91 determines the desired contour and separates the inner useful portion 93 of glass pane 90 from the outer edge portion 94 (also called trim) that is to be removed in the breaking process.

Scribing lines 92a-92d leading from scribing line 91 to edge 95 of the glass pane are auxiliary scribing lines that serve for dividing trim 94 into different edge portions 94a-94d, thereby facilitating a precise breaking of the glass pane.

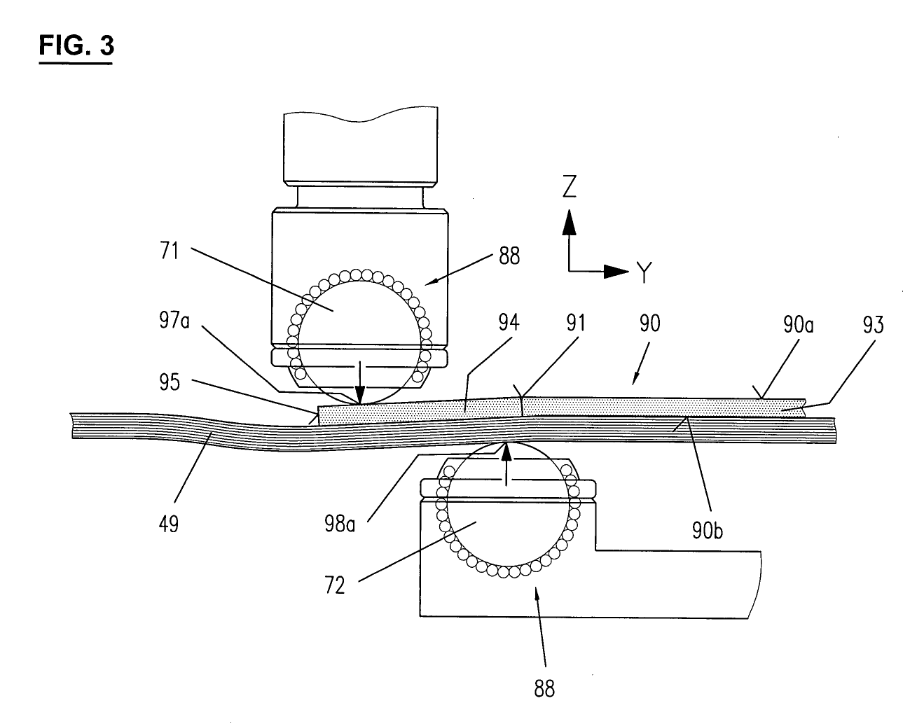

Conveyor belt 49 subsequently transfers the scribed glass pane 90 to breaking station 46 where it is held in place by holding means 77. Second breaking body 72 is applied to the underside of support 49 such that, as appears in FIG. 2, contact point 98a of breaking body 72 is located on trim 94 and slightly offset from scribing line 91. As appears in FIG. 3, first breaking body 71 is applied to upper side 90a of glass pane 90 near edge 95 of the glass pane and laterally offset from second breaking body 72. Contact point 97a of first breaking body 71 and contact point 98a of second breaking body 72 are chosen such as to allow the creation of a bending stress that extends along scribing line 91 and that propagates the break. It will be noted that if one of the breaking bodies is in the form of a roller, the latter will contact the support underside or the glass pane surface 90a along a line rather than on a single point.

After bringing breaking bodies 71 and 72 into contact with the glass pane 90 resp. the support 49, first breaking body 71 is pressed against glass surface 90a with a predetermined force or a predetermined stroke, and the two breaking bodies 71 and 72 are simultaneously displaced along scribing line 91 by means of the synchronizing means. As indicated in FIG. 4 by dashed lines 99a and 100a, the displacement path of the two breaking bodies 71 and 72 is essentially parallel to scribing line 91. Since the two breaking bodies 71 and 72 are laterally offset from each other, a certain moment is exerted on edge 94 which induces the break. Meanwhile, the resilience of support 49 on which underside 90b of glass pane 90 is resting ensures that edge 94 may be pressed down sufficiently to open scribing line 91. On the other hand, glass pane 90 is sufficiently sustained by support 49 to prevent particularly that trim 94a is sheared off and to ensure a precise break along the scribing line. It has been found that even with a relatively short displacement 99a, 100a of the two breaking bodies 71 and 72, the break propagates up to the next auxiliary scribing line 92b.

After the separation of first edge portion 94a, the remaining edge portions 94b-94d are successively broken off in an analogous manner by vertical and horizontal displacement of breaking bodies 71 and 72. In the example of FIG. 4, a total of four separating steps are required, contact points 97b, 98b and displacement paths 99b, 100b indicating the second separating step, contact points 97c, 98c and displacement paths 99c, 100c the third separating step, and contact points 97d, 98d and displacement paths 99d, 100d the fourth separating step.

Subsequently, the useful portion 93 of glass pane 90 is taken over by transfer device 38 and removed. Meanwhile, the broken off glass pieces 94a-94d remain on conveyor belt 49. These are carried in the y direction by displacing conveyor belt 49 until they fall into collecting container 84.

Amongst others, the breaking device and the method of the invention offer the following advantages:
Templates are no longer required for breaking off the edge of the glass pane. Therefore, the processing costs for producing glass panes having user-defined contours can be considerably reduced.
The breaking device resp. the method can be simply and quickly adapted to the particular desired glass pane shape by corresponding programming of the control. An exchange of components such as templates is not required, thereby allowing the production of a series of glass panes of different shapes in a shorter time.
Since the two breaking bodies can be positioned independently of one another, the deformation and breaking of the glass can be effected in a particularly specific manner resp. in a manner adapted to the desired shape.

For reducing the processing time, it is conceivable to provide a second breaking device similar to first breaking device 71, 72 in order to break off different edge portions of the glass pane simultaneously. In the example of FIG. 4, this embodiment allows separating edge portion 94a by the first and edge portion 94c by the second breaking device in a first process step and then edge portion 94b by the first and edge portion 94d by the second breaking device in a second process step. The processing time is thus reduced by half.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A device for breaking a glass pane, comprising:
at least one first breaking body that is displaceable along the front side of the glass pane;
at least one second breaking body that is displaceable along the back side of the glass pane; and
a flexible support that serves for supporting the glass pane and that is arranged between the two breaking bodies.

2. The device according to claim 1, wherein the first breaking body has the shape of a ball or a roller.

3. The device according to claim 1, wherein the second breaking body has the shape of a ball or a roller.

4. The device according to claim 1, further comprising synchronizing means for the synchronized displacement of the two breaking bodies.

5. The device according to claim 1, wherein the flexible support is displaceable.

6. The device according to claim 1, further comprising at least one rotatable arm along which one of the two breaking bodies is displaceable.

7. The device according to claim 1, further comprising holding means for holding the glass pane in place during the breaking operation.

8. The device according to claim 7, wherein the holding means comprise at least one suction device.

9. A method for breaking a glass pane lying on a flexible support, the method comprising:
displacing a first breaking body along the front side of the glass pane and a second breaking body along the back side of the glass pane,
the breaking bodies being displaced synchronously.

10. The method according to claim 9, wherein the first breaking body or the second breaking body or both are pressed against the glass pane with a predetermined force.

11. The method according to claim 9, wherein the first breaking body or the second breaking body or both are pressed against the glass pane with a predetermined stroke.

12. The method according to claim 9, wherein the two breaking bodies are displaced laterally offset relative to one another and essentially parallel to the scribing line along which the glass pane is to be broken.

13. The method according to claim 9, wherein the glass pane is maintained in the same position during the breaking procedure.
